(19) United States
(12) Patent Application Publication
(10) Pub. No.: US 2012/0053763 A1
(43) Pub. Date: Mar. 1, 2012

(54) INCEPTOR SYSTEM

(75) Inventors: Matthias Stiefenhofer, Lindenberg (DE); Matthias Ludwig, Lindenberg (DE); Michael Rottach, Sulzberg (DE); Ralph Neumann, Scheidegg (DE); Manfred Schlosser, Lindenberg (DE)

(73) Assignee: Liebherr-Aerospace Lindenberg GmbH, Lindenberg (DE)

(21) Appl. No.: 13/218,683

(22) Filed: Aug. 26, 2011

(30) Foreign Application Priority Data
Aug. 30, 2010 (DE) 102010035823.1

(51) Int. Cl. B64C 13/46; G05D 1/00

(52) U.S. Cl. 701/3

(57) ABSTRACT

The present invention relates to an active inceptor system for controlling an aircraft with at least one mechanically movable inceptor, at least one control of at least one control element or actuator for actuating the inceptor, and at least one detection means for detecting at least one state variable of the inceptor, wherein the active inceptor comprises at least one controller for actuating at least one control element or actuator and at least one feel generating means, wherein the feel generating means combines inner and/or outer state variables and a control setpoint variable can be determined with the aid of one or more physical-mathematical models.

### BACKGROUND OF THE INVENTION

This invention relates to an active inceptor system for controlling an aircraft with at least one mechanically movable inceptor, at least one control of at least one control element or actuator for actuating the inceptor, and at least one detection means for detecting at least one state variable of the inceptor.

Such inceptor systems employ an inceptor mechanically movable about a plurality of axes, in particular in the form of a control stick, which can be actuated by the pilot for flight control of an aircraft. The inclination of the inceptor about one of the axes for example influences the longitudinal and/or transverse inclination of an airplane or the pitch and roll movement as well as the vertical movement of a helicopter.

In contrast to the classical control, in which the control movements of the pilot are transmitted to the controlling actuating devices of the aircraft by steel cables, push rods or other hydraulic systems, the variable actuating position of the mechanically movable inceptor is detected by associated sensors and transmitted to the corresponding actuating device of the aircraft via electric lines.

In the design of the fly-by-wire system, as compared to the classical control stick design, the occurring control forces are not fed back to the inceptor. However, the pilot often must rely on this form of haptic transmission of information, in order to feel the respective flight position of the aircraft.

The active inceptor systems provide for simulating the occurring control forces and adapt the same to the respective flight situation, so as to achieve an optimum support of the pilot. The feedback for example is transmitted to the control device in the form of movements or signals, whereby an intuitive reaction of the pilot to the respective flight situation is facilitated. Furthermore, the pilot gets a precise feedback on the control inputs made by him. Even when using an electric control system, it is therefore possible for the pilot to feel the behavior of the aircraft during the flight operation.

### SUMMARY OF THE INVENTION

It is the object of the present invention to present an inceptor system for aircraft with an improved feel generation.

This object is solved by an active inceptor system according to the features herein. Further advantageous embodiments of the inceptor system are subject-matter of the description herein.

Accordingly, a generic active inceptor system for controlling an aircraft is developed to the effect that the same comprises at least one controller for controlling at least one control element or actuator and at least one feel generating means. The feel generating means is directly or indirectly connected with at least one detection means of the inceptor system. Taking into account at least one inner state variable, at least one control setpoint variable can be determined for actuating the controller by means of one or more physical-mathematical models. The resulting regulated actuation of the actuator/control element generates a perceptible feel for the pilot, which substantially corresponds to the known control forces of classical control systems.

Preferably, inner state variables and outer state variables are combined inside the feel generating means and employed for the control setpoint variable determination with the aid of one or more physical-mathematical models.

Inner state variables directly concern the state of the inceptor, i.e. the position and/or the speed and/or acceleration and/or action of force with which the inceptor is actuated by the pilot. Outer state variables preferably describe the state of coupled components or the state of external components which are important for the control of the aircraft.

The physical-mathematical model allows the detailed and adaptable simulation of the control forces occurring in classical control systems. The combination of different physical-mathematical models allows an adaptable and arbitrarily adjustable configuration of the feedback reactions perceptible for the pilot. The manner of the respective feel generation can be adapted to the aircraft or to the flight behavior.

Preferably, at least one physical-mathematical model comprises a characteristic curve and/or a spring-mass damper model of any order and/or dimension.

By means of the feel generating means various functions can be realized in the feel generating means. The combination of different functions is possible. Possible physical-mathematical models comprise force position characteristic curves, torque position characteristic curves or damping speed characteristic curves, which preferably are linear or non-linear.

Furthermore a physical-mathematical model for realizing a detent, a break-out, a hard stop (position limitation) or a soft stop function is conceivable. What is also possible is the realization of a friction model, a force offset, a position offset or a stick shaker. Furthermore, the speed and/or the acceleration and/or the force can be limited by the physical-mathematical model. An arbitrary combination of the aforementioned functions inside the feel generating means is conceivable.

The inner state variables preferably are detected by the above-mentioned detection means and transmitted to the feel generating means. The same include for example the hand force and/or the hand torque acting on the inceptor.

Outer state variables expediently comprise one or more signals of an autopilot. Measured values or relevant data of other coupled components likewise can be taken into account. The same include for example an active inceptor system installed in parallel. Control data, like arbitrary state variables, as well as determined setpoint variables of a parallel active inceptor system are transmitted to the feel generating means of the active inceptor system according to the invention. Inceptor systems installed in parallel for example play a role in aircraft which are steered by more than one person. Furthermore, parallel inceptor systems can perform a plurality of control functions of an aircraft. A redundant design of the inceptor system according to the invention also is imaginable under the aspects mentioned above.

Taking into account the inner and/or outer state variables, the feel generating means according to the invention generates one or more control setpoint variables for the control architecture of the inceptor system according to the invention. Preferably, the control architecture is based on at least one movement controller.

In particular, the controller is designed as position controller and the feel generating means generates a desired position variable for the controller.

Furthermore, the controller can be designed as speed controller and the feel generating means generates a desired speed variable for the controller.

The design of the controller as acceleration controller likewise is conceivable, and the feel generating means generates a desired acceleration variable for the controller.

A combination of all three control architectures is also possible.

This invention furthermore relates to an aircraft with an active inceptor system according to any of the advantageous embodiments explained above. The properties and effects of the aircraft according to the invention quite obviously correspond to those of the advantageous embodiments of the active inceptor system, so that a repeated discussion thereof will be omitted at this point.

### BRIEF DESCRIPTION OF THE DRAWINGS

Further advantages and details of the invention can be taken from the exemplary embodiments shown in FIGS. 1 and 2. In the drawing:

FIG. 1: shows a block circuit diagram of the architecture of the active inceptor system, and

FIG. 2: shows a schematic representation of the mode of operation of the feel generating means.

### DESCRIPTION OF THE PREFERRED EMBODIMENTS

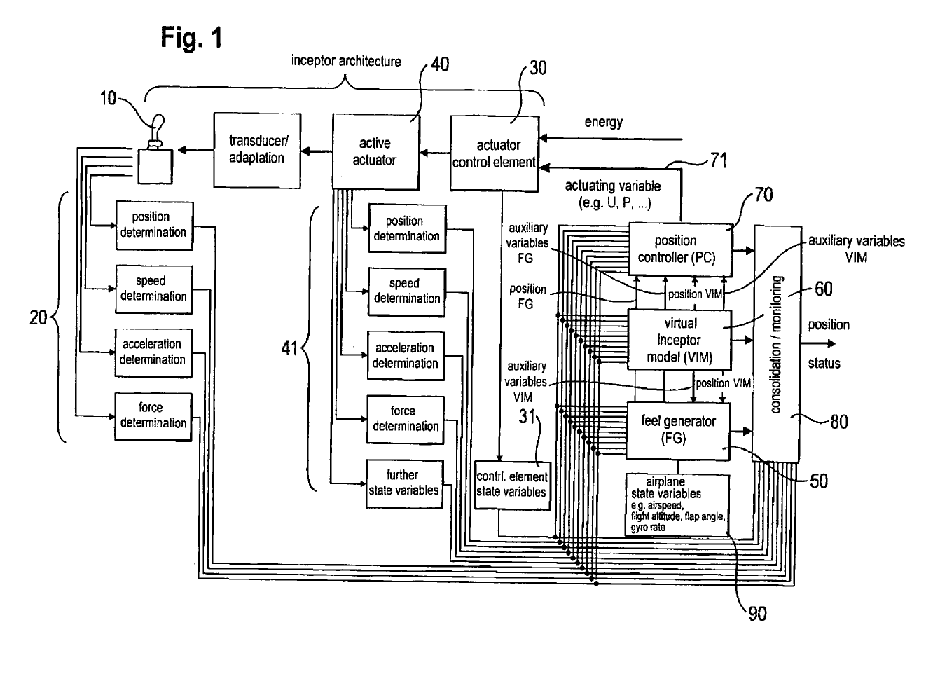

FIG. 1 shows a block circuit diagram of an active inceptor unit. The architecture comprises a mechanically movable inceptor in the form of a control stick 10 which is mechanically connected with at least one control element 30 or at least one active actuator 40. The actuator 40 preferably is designed as electric motor whose drive shaft causes a mechanical force acting on the control stick 10 via a transmission structure and generates a control stick movement. Since the control stick 10 is freely movable about an arbitrary number of axes, one control element 30 or actuator 40 is provided per axis.

The architecture furthermore comprises detection means 20 which are arranged at the stick mechanism and serve for determining the current actuating position of the control stick 10. Parameters such as the speed, the acceleration and the force, which act on the control stick 10 when the same is actuated, likewise can be determined by the detection means 20. Further sensors determine the current state variables 31, 41 of the used actuators 40 or control elements 30 for actuating the control stick 10.

For generating the electronically controlled feedback in dependence on the control stick actuation the feel generating means 50 is used. At the input of the feel generating means 50 the signals of the internal state variables 20, 31, 41 generated by the sensors are present. Furthermore, the position controller 70 makes use of said signal lines of the sensors.

For considering the current flight position of the aircraft external state variables 90 furthermore are detected by external sensor systems and forwarded to the feel generating means 50. The external state variables 90 for example include the current airspeed, the flight altitude, the set flap angle and the measurement data of the gyroscopes used in the airplane and corresponding signals of the autopilot.

The virtual inceptor model 60 generally is based on a mathematical model which generates a virtual control stick. In consideration of the incoming state variables 20, 31, 41 the inceptor model 60 generates a plurality of simulation values which comprise a virtual position as well as further auxiliary variables of the control stick 10. The simulation data are supplied to the position controller 70 and to the feel generating means 50. For example, an explicit measurement of certain state variables can be omitted, since the same can be calculated by means of the virtual inceptor model 60 in consideration of the incoming state variables 20, 31, 41.

By using the virtual inceptor model 60, a force measurement or a force control theoretically can be omitted completely.

From the supplied state variables 20, 31, 41 of the sensors, the virtual state and auxiliary variables of the virtual inceptor model 60 and the external state variables 90 the feel generating means 50 generates a desired position for the control stick 10. The desired position can be generated by using a stored characteristic curve or a feel model, to which different behavioral characteristics can be assigned. By way of example the use of a spring-mass model or an arbitrary force-position characteristic curve should be mentioned, which in dependence on an incoming force state variable determines a predefined desired position for the control stick 10. Further embodiments employ an attenuation speed characteristic curve or simulate a detent and/or break-out and/or position limitation and/or soft stop function and/or a friction model and/or a force or position offset and/or a force and/or speed limitation.

At the actual input of the position controller 70 the state variables 20, 31, 41 of the inceptor 10 and of the actuators 40 or control elements 30 are present. Taking into account the desired position generated by the feel generating means 50 and taking into account the virtual auxiliary variables determined by the virtual inceptor model 60, a corresponding actuating variable 71 is generated for the control elements 30 of the inceptor architecture. The actuating variable 71 includes e.g. arbitrary control voltages, control currents as well as other control variables for the motor or control element actuation.

For safety reasons, the control stick system comprises a consolidation or monitoring means 80 which monitors the generated variables of the position controller 70 as well as the generated variables of the feel generating means 50 and of the virtual inceptor model 60 and possibly subjects the same to a plausibility check. The respective data of the monitoring or consolidation means 80 optionally are output acoustically via a display element or optically as status message.

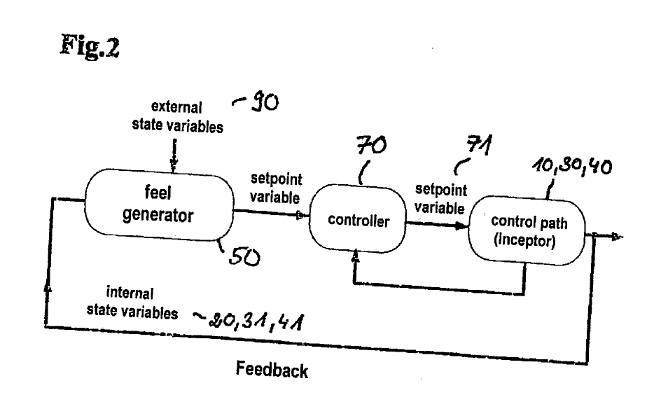

The rough schematic diagram of FIG. 2 once again illustrates the mode of operation of the feel generating means 50 according to the invention. Taking into account one or more incoming inner and outer state variables and on the basis of a physical-mathematical model to be chosen arbitrarily, the basic architecture of the feel generating means 50 generates a control setpoint variable which is supplied to the succeeding controller 70. The generated actuating variable 71 at the controller output is provided to the individual control elements 30, 40 for actuating the control stick 10. The actual control variable at the output of the control path is fed back to the feel generating means 50 as inner state variable.

Since an aircraft often is equipped with a plurality of inceptor units as shown in FIG. 1 for reasons of redundancy, a coupling must be effected between the used systems. The communication between the two systems is realized by means of an electric connection. Status messages of the monitoring or consolidation means or the used state variables of the actuators or control elements and of the inceptors for example are exchanged between the control architectures of the coupled systems.

Alternatively, a plurality of inceptors or inceptor systems is used not for redundancy reasons, but instead for realizing various control tasks. For example, a side stick serves for executing a roll and pitch movement of a helicopter, whereas a second side stick controls the vertical movement. Here as well, a synchronized feel generation on both sticks as well as the exchange of various status messages and state variables is absolutely necessary.

1. An active inceptor system for controlling an aircraft with at least one mechanically movable inceptor, at least one control of at least one control element or actuator for actuating the inceptor, and at least one detection means for detecting at least one state variable of the inceptor, wherein
the active inceptor system comprises at least one controller for actuating at least one control element or actuator and at least one feel generating means, and the feel generating means combines inner and/or outer state variables and determines a control setpoint variable with the aid of one or more physical-mathematical models.

2. The active inceptor system according to claim 1, wherein at least one physical-mathematical model comprises a characteristic curve and/or a spring-mass damper model of any order and/or dimension.

3. The active inceptor system according to claim 1, wherein an inner state variable considers the hand force and/or the hand torque acting on the inceptor.

4. The active inceptor system according to claim 1, wherein outer state variables comprise data of the autopilot or measured values or data of coupled components.

5. The active inceptor system according to claim 1, wherein the controller used is a position controller and the feel generating means generates a position setpoint variable.

6. The active inceptor system according to claim 1, wherein the controller used is a speed controller and the feel generating means generates a speed setpoint variable.

7. The active inceptor system according to claim 1, wherein the controller used is an acceleration controller and the feel generating means generates an acceleration setpoint variable.

8. The active inceptor system according to claim 1, wherein control architecture is configured according to an arbitrary combination of
the controller used being a position controller and the feel generating means generates a position setpoint variable, or
the controller used is a speed controller and the feel generating means generates a speed setpoint variable, or
the controller used is an acceleration controller and the feel generating means generates an acceleration setpoint variable.

9. An aircraft with an active inceptor system according to claim 1.

10. The active inceptor system according to claim 2, wherein an inner state variable considers the hand force and/or the hand torque acting on the inceptor.

11. The active inceptor system according to claim 10, wherein outer state variables comprise data of the autopilot or measured values or data of coupled components.

12. The active inceptor system according to claim 3, wherein outer state variables comprise data of the autopilot or measured values or data of coupled components.

13. The active inceptor system according to claim 2, wherein outer state variables comprise data of the autopilot or measured values or data of coupled components.

14. The active inceptor system according to claim 13, wherein the controller used is a position controller and the feel generating means generates a position setpoint variable.

15. The active inceptor system according to claim 12, wherein the controller used is a position controller and the feel generating means generates a position setpoint variable.

16. The active inceptor system according to claim 11, wherein the controller used is a position controller and the feel generating means generates a position setpoint variable.

17. The active inceptor system according to claim 10, wherein the controller used is a position controller and the feel generating means generates a position setpoint variable.

18. The active inceptor system according to claim 4, wherein the controller used is a position controller and the feel generating means generates a position setpoint variable.

19. The active inceptor system according to claim 3, wherein the controller used is a position controller and the feel generating means generates a position setpoint variable.

20. The active inceptor system according to claim 2, wherein the controller used is a position controller and the feel generating means generates a position setpoint variable.
